(19) United States
(12) Patent Application Publication
(10) Pub. No.: US 2003/0033355 A1
(43) Pub. Date: Feb. 13, 2003

(54) Onboard multimedia caching for communication satellites

(76) Inventors: Oliver W. Saunders, Los Angeles, CA (US); Zoltan Z. Stroll, Rancho Palos Verdes, CA (US)

Correspondence Address: PATENT COUNSEL, TRW Inc., Space & Electronics Group, One Space Park, E2/60751, Redondo Beach, CA, 90278, US

(21) Appl. No.: 09/924,996

(22) Filed: Aug. 8, 2001

(51) Int. Cl. G06F 15/16

(52) U.S. Cl. 709/203; 709/231

(57) ABSTRACT

A caching subsystem and method for a communication satellite includes an uplink demodulator that produces demodulated data on a demodulated data output for storage in a memory cache. This also includes a switched-router coupled to the solid state recorder. A processor outputs a first preselected time delay control signal to the memory cache to generate a first time delayed data stream. In addition, the processor subsequently outputs a second preselected time delay control signal to the solid state recorder to generate a second time delayed data stream. The solid state recorder and processor act in concert to provide a variable time delay pipeline for program data. The uplink demodulator also produces a program data identifier and a delivery request. The processor outputs a control signal to the solid state recorder to generate independent downlink data streams from the program data at delivery times and delivery dates specified by delivery requests.

### CROSS-REFERENCE TO RELATED APPLICATIONS

This application is related to U.S. patent application Ser. No. 09/567,853, titled “Satellite-Based Communications System Having An Onboard Internet Web Proxy Cache”, filed on May 9, 2000, and TRW Docket No. 22-0122, titled “Processing Satellite Web Proxy Cache”, filed on concurrently herewith.

### BACKGROUND OF THE INVENTION

The present invention relates to satellite communication systems. In particular, the present invention relates to caching multimedia data onboard a satellite for subsequent retrieval and transmission.

Satellites have long provided communication bandwidth on a global scale. Voice, video, and data traffic routinely circle the globe, aided by satellite relays that interface with terrestrial networks. The far reaching information delivery capabilities of a satellite typically mean that the satellite uplink and downlink bandwidth are in extremely high demand and thus extremely valuable.

In the past, however, the satellite served solely as a transmission relay device. In other words, the satellite, in bent-pipe fashion, passed all data from ground storage and transmission areas to a ground terminal requesting the data without intermediate processing or storage. Thus, multiple requests for the same data typically required transmitting that data multiple times. As an example, a network television broadcast scheduled to be transmitted at different times in different regions of the United States required separate, duplicative, transmissions of the television broadcast each time the television broadcast was scheduled to be aired across the country. Duplicative use of the uplink and downlink bandwidth is extremely wasteful, and may, for example, prevent the communication of other important revenue generating data through the satellite.

A need has long existed in the industry for a satellite architecture that addresses the problems noted above and others previously experienced.

### BRIEF SUMMARY OF THE INVENTION

A preferred embodiment of the present invention provides a multimedia caching subsystem for a communication satellite. The caching subsystem includes an uplink demodulator that produces demodulated data on a demodulated data output for storage in a memory cache.

The memory cache includes a processor coupled to a high capacity memory. The processor outputs first preselected time delay control signals to the memory to generate a first time delayed data stream. In addition, the processor subsequently outputs second preselected time delay control signals to the memory to generate a second time delayed data stream. The time delayed control signals may comprise, for example, address and data bus signals that retrieve program data from the memory at a time specified by a transmission schedule.

Thus, the memory provides a time delay mode of operation. In other words, the memory and processor act in concert to provide a variable time delay pipeline for program data. As a result, for example, the first time delayed data stream may be sent to a particular time zone covered by a first downlink, while the second time delayed data stream may be sent to a different time zone by a different downlink at the same terrestial time (e.g., 9 PM).

The memory may be one or more solid state recorders, preferably of very large capacity. The memory may be, for example, hundreds of megabytes to hundreds of terabytes, or larger, in size suitable for storing television programming, music, and the like, optionally encoded and compressed according, for example, to the Digital Video Broadcasting standard, Motion Picture Experts Group standard, or the like.

In another preferred embodiment, the caching subsystem includes an uplink demodulator producing program data, a program data identifier, and a delivery request on a demodulator output. A high capacity memory is coupled to the data output for storing the demodulated data and the program data identifier. In addition, a processor coupled to the memory outputs a control signal to the memory to generate a downlink data stream from the program data when specified by the delivery request (e.g., specifying a delivery time and a delivery date).

Thus, the memory acts to provide intermediate or long term storage of multimedia programming. As a result, the most commonly requested movies (for example) may be stored on the satellite and downlinked by the satellite, rather than requiring repetitious, duplicative use of uplink resources. In other words, each multimedia program may be stored independently in the memory, with individual delivery requests handled by the processor to generate individual responsive downlink data streams.

### BRIEF DESCRIPTION OF THE DRAWINGS

FIG. 1 illustrates a block diagram of a caching subsystem for a communication satellite.

FIG. 2 depicts an interface between a switched-router and a memory cache.

FIG. 3 shows a block diagram of a high capacity memory cache.

FIG. 4 shows a block diagram of a caching subsystem integrated with Skyplex™ processor elements.

FIG. 5 illustrates a flow diagram of a method of operating a communication satellite caching subsystem.

### DETAILED DESCRIPTION OF THE INVENTION

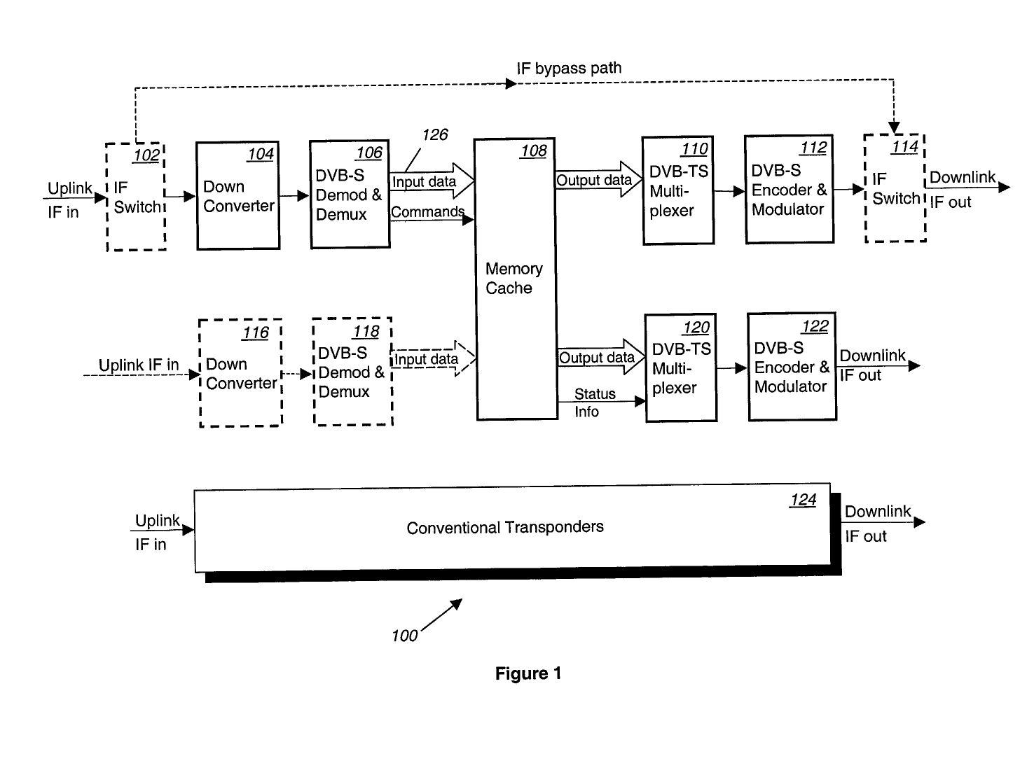

Turning now to FIG. 1, that figure illustrates a block diagram of a caching subsystem 100 for a communication satellite. The caching subsystem 100 includes a first IF switch 102, an uplink downconverter 104, and a Digital Video Broadcasting (DVB) demodulator and demultiplexer 106 coupled to a high capacity memory cache 108. The memory cache 108, in turn, is coupled to a DVB multiplexer 110, a DVB encoder and modulator 112, and a second IF switch 114 that interfaces with downstream downlink waveform processing and transmission hardware. In general, the digital processing elements identified above may be implemented in a single ASIC or set of ASICs, for example.

The satellite may support multiple simultaneous uplinks and downlinks, and to that end, the caching subsystem 100 may include a second downconverter 116 coupled to a second DVB demodulator and demultiplexer 118 that feeds the memory cache 108. In turn, the memory cache 108 additionally feeds the second DVB multiplexer 120, followed by the second DVB encoder and modulator 122.

As an initial matter, note that the first IF switch 102 (e.g., a ferrite switch) and the second IF switch 114 provide a bypass path around the memory cache 108. Thus, uplink data may be passed directly to an appropriate downlink without caching. To that end, a control element (such as the processor described below) may assert switching signals to the IF switch 102 and the IF switch 144. In other words, the caching subsystem may support functionality similar to that provided by the conventional transponder 124.

On the other hand, the IF switch 102 may instead direct an uplink to the downconverter 104 (for translation to an IF or baseband), and subsequently to the DVB demodulator and demultiplexer 106. The DVB demodulator 106 removes and decodes DVB standard modulation and encoding to recover demodulated data (e.g., television programming) that represents original data before encoding according to the DVB standard. The demodulated data output 126 provides the demodulated data to the memory cache 108.

The memory cache 108 preferably includes a high capacity solid state recorder, available, for example, from TRW Space and Electronics Group, Redondo Beach, Calif. The solid state recorder typically provides hundreds of megabytes to terabytes of storage suitable for recording many hours of television programming and other multimedia content (e.g., music, video games, and the like).

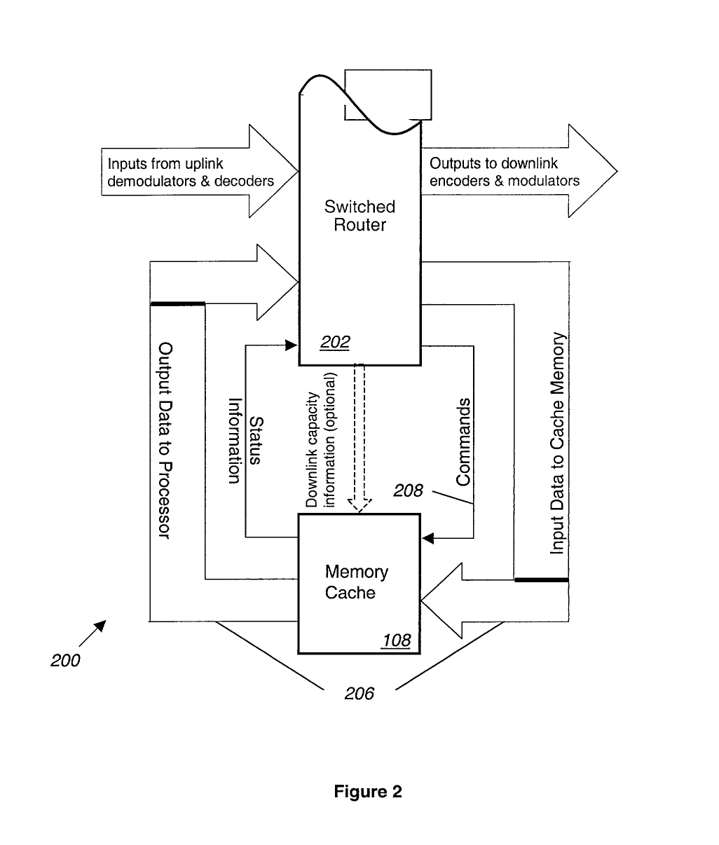

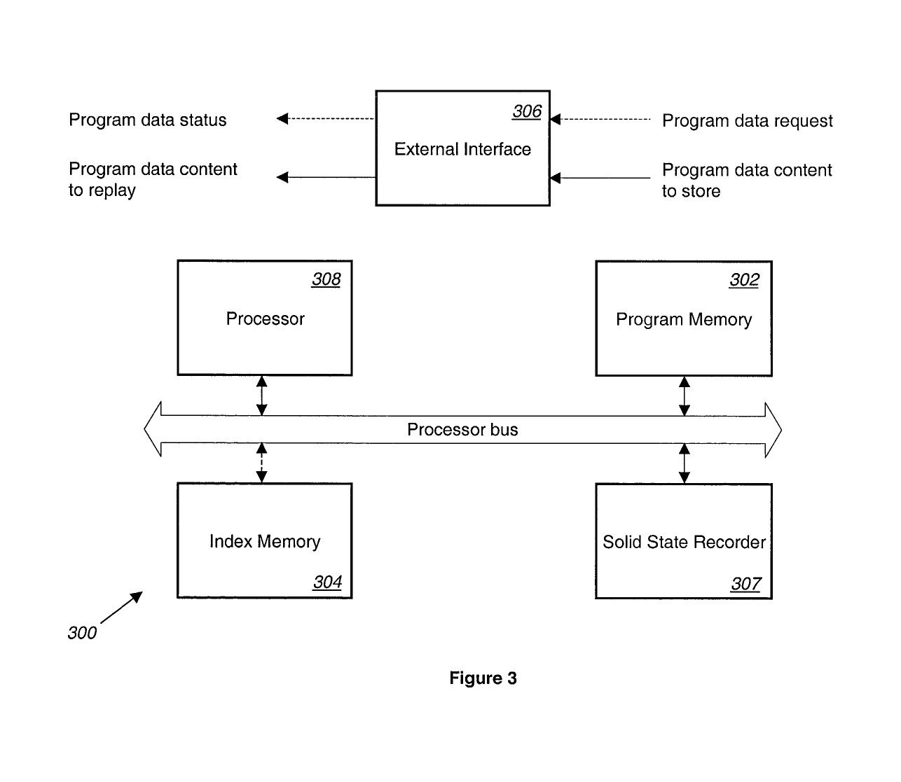

The DVB multiplexer 110 multiplexes DVB data retrieved from the memory cache 108 in response to a delivery request. As an example, the delivery request may include a delivery time, a delivery date, and a program identifier. Subsequently, the DVB encoder and modulator 112 format the multiplexed DVB data for transmission in the downlink. The operation of the caching subsystem 100 is generally under the control of a switched-router and processor or other control circuit as illustrated in FIGS. 2 and 3.

With respect to FIG. 2, that figure shows an interface 200 between a switched-router 202 and the high capacity memory cache 108. A data bus 206 and command bus 208 allow demodulated program data and program data identifiers to be stored in the memory cache 108. A program identifier may be, for example, an alphanumeric string or binary code that identifies the program data and that is derived from, or transmitted separately from the program data.

Memory status information may be communicated back to the switched-router 202 (e.g., remaining memory capacity, status of pending delivery requests, failure of portions of the memory, and the like). In addition, downlink status information (e.g., available downlink bandwidth) may be communicated to the memory 108 and switched-router 202 so that the downlink is not idle when there is program data to be transmitted.

The switched-router 202 may, in cooperation with the processor 308 (FIG. 3) use a portion of the solid state recorder 307 as a variable tap time delay. As an example, assume that the solid state recorder 307 provides three hours of program data recording capability. Then, after one hour of data has been stored in the solid state recorder 307, the processor 308 may assert time delay control signals (i.e., memory address and control signals) to read the solid state recorder 307 and generate a resultant downlink data stream. The processor 308 may then wait one hour and assert time delay control signals to again read and downlink data from the solid state recorder 307. Finally, the processor 308 may again wait another hour, then assert time delay control signals to read and downlink the program data. Thus, the processor 308 and solid state memory 307 operate in concert to provide the same program data at variable time delays (one hour, two hours, and three hours in this example). The program data in each instance may be delivered to downlinks covering different time zones, for example at the same Earth time (e.g., 9 PM) in each time zone.

A portion of the solid state recorder 307 may be used for extended storage of program data. As an example, the extended storage may provide storage for those programs statistically expected to be most requested, most watched, or the like. Thus, when a delivery request specifying such a program is received (either received and decoded by the satellite itself, or received from a ground control center), the processor 308 retrieves the appropriate program data and begins streaming the program data to the requesting user in a downlink. Because the program data resides entirely in the solid state recorder 307, no uplink bandwidth is needed to meet multiple delivery requests. Program data in the solid state recorder 307 may be replaced on a dynamic or scheduled basis, depending, for example, on the expected demand for a particular program.

A more detailed block diagram 300 of the memory cache 108 is shown in FIG. 3. In particular, the processor 308 connects to a program memory 302, an index memory 304, and a high capacity memory 307 (e.g., a solid state recorder). In addition, an external interface 306 provides bi-directional support circuitry for communications with the switched-router 202. The switched-router 202 thereby routes streaming program data to one or more output ports connected to downlink processing elements.

The program memory 302 typically stores instructions for execution by the processor 308. The instructions may include memory indexing and program data storage routines, for example, that implement binary heap routines, and the like. The program memory 302 many also store constructed and updated program data index tables (e.g., program data address indexes) for the memory cache 108 preprogrammed program data replay schedules, and the like. Alternatively, the indexing task may be accomplished at a ground control center and uplinked to the processor 308. The separate index memory 304 may store, for example, program data indexes (i.e., storing address information about the program data currently in memory), content indexes (i.e., program identifier, etc.), and also program replay schedules (that determine which programs are downlinked at what times).

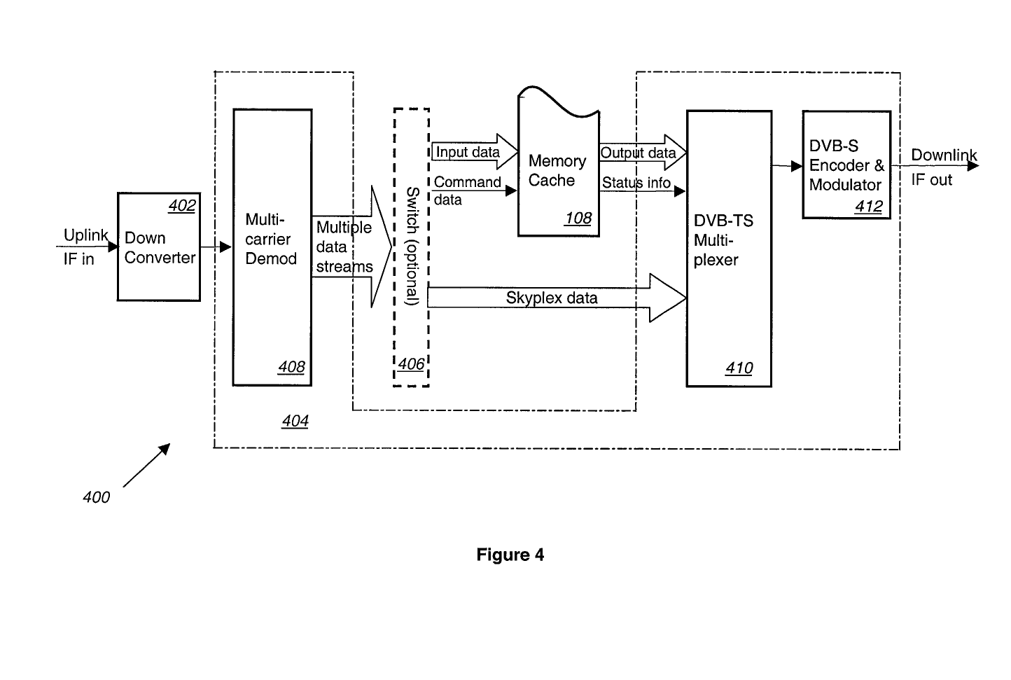

With regard to FIG. 4, a block diagram of a caching subsystem 400 integrated with Skyplex™ processor elements (developed by the European Space Agency and Eutelsat) is shown. In particular, the subsystem 400 includes a downconverter 402, a Skyplex™ section 404, a switch 406, and the memory 108. The Skyplex™ section 404 includes a multi-carrier demodulator 408, a DVB multiplexer 410, and a DVB encoder and modulator 412.

The output of the demodulator 408 is one or more independent streams of program data and Skyplex™ control or overhead data. The switch 406 routes the output of the demodulator 408 appropriately, including forwarding Skyplex™ control and overhead data to the DVB multiplexer 410, while providing the streams of program data to the memory cache 108 where they may be stored for later retrieval. As discussed above, under processor control, output data streams (optionally time delayed) make their way from the memory cache 108 to the DVB multiplexer 410 and subsequently to the DVB encoder and modulator 412 for transmission in a downlink.

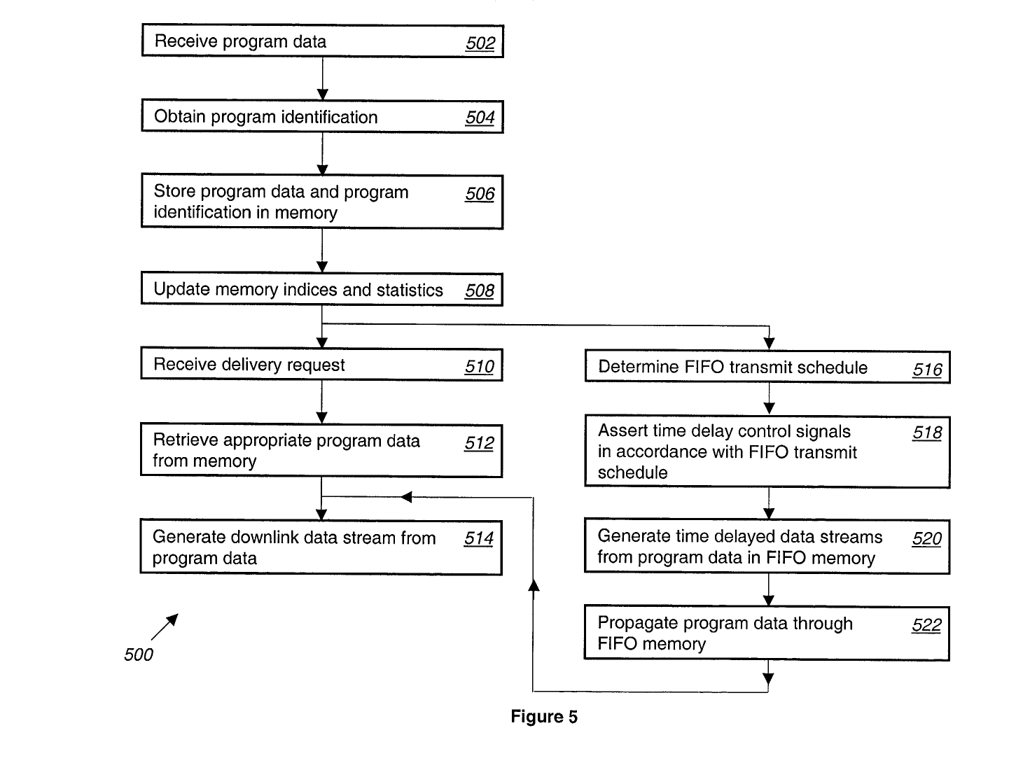

The method of operation of the caching subsystem 100 is summarized in FIG. 5, in the flow diagram 500. First, the caching subsystem 100 receives (502) program data (e.g., DVB encoded television programs) and obtains (504) an associated program data identification. Next, the caching subsystem 100 stores (506) the program data and the program identification in memory 307. Accordingly, the processor 308 updates (508) memory indices and usage statistics.

Subsequently, the caching subsystem 100 receives (510) (in one mode of operation) a delivery request including, for example, a delivery date, program identifier, and a delivery time. The processor 308, at the appointed date and time accesses the memory 307 to retrieve (512) the specified program data. The program data, as it is retrieved, generally generates (514) a stream of downlink data destined to the requesting ground terminal in a downlink.

In an alternate mode of operation, the processor 308 determines (516) a transmit schedule. To that end, the transmit schedule may be uplinked to the satellite from a ground control center, for example. The transmit schedule specifies the program data, and the time delays at which to retrieve the program data from the solid state memory 307. Next, the processor 308 asserts (518) time delay control signals to the memory 307 as specified by the transmit schedule. As a result, the processor 308 generates (520) time delayed program data streams from the program data in the solid state memory 307. The program data is propagated (522) to generate (514) the downlink data stream.

Note that delivery of program data in response to a second later received delivery request may occur while that same program data is already being downlinked (in response to a first delivery request.) The second requester is thus granted access to the program data in the downlink. The processor 308 may also then track the progress of the transfer to the second requester to ensure that, although the second requester begins reception in the middle of the program data, the remaining initial portion of the program data is subsequently transmitted to the second requester. The ground processing elements associated with the second requester would then organize the program data into a complete program data file. In other words, the program data may be treated as circular objects rather than linear objects, and the transmission of the program data may be completed by looping back to the beginning of the program data regardless of when a subsequent requester begins receiving.

Thus, multiple requests for the same program data need not be uplinked multiple times. In addition, time shifted versions of the same program may be provided using the memory cache 108. As a result, the duplicative use of uplink bandwidth is avoided, and additional revenue generating data may instead be transmitted through the communication satellite. The caching subsystem 100 described above supports simultaneous input and output of unrelated data streams, simultaneous input and output of the same data stream, simultaneous input of multiple unrelated data streams (e.g., from independent uplinks), and simultaneous output of multiple unrelated or time shifted versions of the same data stream. Any uplink bandwidth availability may be used to transfer data into the memory 108. Thus, constant bit rate, variable bit rate, available bit rate, and even unspecified bit rate modes may be used with the caching subsystem.

While the invention has been described with reference to a preferred embodiment, those skilled in the art will understand that various changes may be made and equivalents may be substituted without departing from the scope of the invention. As an example, the DVB format is only one of many possible coding techniques (including MPEG and other standards) that may be used. In addition, many modifications may be made to adapt a particular step, structure, or material to the teachings of the invention without departing from its scope. Thus, for example, multiple independent high capacity memories may instead be used. Therefore, it is intended that the invention not be limited to the particular embodiment disclosed, but that the invention will include all embodiments falling within the scope of the appended claims.

What is claimed is:

1. A multimedia caching subsystem for a communication satellite, the caching subsystem comprising:
an uplink demodulator producing demodulated data on a demodulated data output;
memory coupled to the data output for storing the demodulated data; and
a processor coupled to the memory, the processor outputting a first preselected time delay control signal to the memory to generate a first time delayed data stream, and a second preselected time delay control signal to the memory to generate a second time delayed data stream.

2. The caching subsystem of claim 1, further comprising a first downlink modulator coupled to the memory.

3. The caching subsystem of claim 2, wherein the first downlink modulator is a Digital Video Broadcast modulator.

4. The caching subsystem of claim 1, further comprising a first downlink modulator modulating first data for a first time zone downlink, and a second downlink modulator modulating second data for a second time zone downlink.

5. The caching subsystem of claim 1, wherein the memory is a solid state recorder.

6. The caching subsystem of claim 1, wherein the demodulated data is at last one of television program data, music data, and video game data.

7. A caching subsystem for a communication satellite, the caching subsystem comprising:
an uplink demodulator producing program data, a program data identifier, and a delivery request on a demodulator output;
a memory coupled to the data output f or storing the demodulated data and the program data identifier;
a processor coupled to the memory, the processor outputting a control signal to the memory to generate a downlink data stream from the program data when specified by the delivery request.

8. The caching subsystem of claim 7, wherein the delivery request comprises a delivery time and a delivery date.

9. The caching subsystem of claim 7, further comprising a downlink modulator coupled to the memory.

10. The caching subsystem of claim 7, wherein the memory is a solid state recorder.

11. The caching subsystem of claim 7, wherein the memory also stores second program data and a second program data identifier, and wherein the processor outputs a second control signal to the memory to generate a second downlink data stream from the second program data when specified by a second delivery request.

12. The caching subsystem of claim 7, further comprising a Digital Video Broadcast decoder coupled between the uplink demodulator and the memory.

13. The caching subsystem of claim 12, further comprising a Digital Video Broadcast coder coupled to the processor for formatting the downlink data stream.

14. A method for caching program data in a communication satellite, the method comprising:
receiving program data on an uplink;
obtaining a program identifier associated with the program data;
caching the program data in a memory;
retrieving the program data from the memory at a predetermined future time according to at least one of a delivery request and a delivery schedule; and
generating a first downlink data stream from program data retrieved from the memory.

15. The method of claim 14, wherein retrieving comprises retrieving according to the delivery request, and wherein the delivery request comprises a delivery time, delivery date, and the program identifier.

16. The method of claim 14, wherein receiving program data comprises receiving Digital Video Broadcast program data.

17. The method of claim 16, bypassing the memory using an IF bypass path.

18. The method of claim 15, wherein caching comprises caching in a solid state recorder.

19. The method of claim 14, wherein retrieving comprises retrieving according to the delivery schedule.

20. The method of claim 14, further comprising outputting a first preselected time delay control signal to the memory to generate a first time delayed data stream.

21. A method for caching program data in a communication satellite, the method comprising:
receiving program data on an uplink;
obtaining a program identifier associated with the program data;
caching the program data in a memory;
retrieving the program data from the memory at a predetermined future time according to at least one of a delivery request and a delivery schedule;
generating a first downlink data stream from program data retrieved from the memory;
receiving a second delivery request; and
generating a second downlink data stream in response simultaneously with the first downlink data stream.

22. A method for caching program data in a communication satellite, the method comprising:
receiving program data on an uplink;
obtaining a program identifier associated with the program data;
caching the program data in a memory;
retrieving the program data from the memory at a predetermined future time according to at least one of a delivery request and a delivery schedule;
generating a first downlink data stream from program data retrieved from the memory;
outputting a first preselected time delay control signal to the memory to generate a first time delay control signal to the memory to generate a first time delayed data stream; and
outputting a second preselected time delay control signal to the memory to generate a second time delayed data stream with a delay different than the first time delayed data stream.

23. The method of claim 22, further comprising downlinking the first time delayed data stream to a first time zone at a preselected terrestrial time, and downlinking the second time delayed data stream to a second time zone at the preselected terrestrial time.
